(19) United States
(12) Patent Application Publication
(10) Pub. No.: US 2011/0314392 A1
(43) Pub. Date: Dec. 22, 2011

(54) INCORPORATING CALENDAR INTERFACES TO DYNAMICALLY ADJUST PRESENTATION INFORMATION

(75) Inventor: Arthur G. Howarth, Orleans (CA)

(73) Assignee: Cisco Technology, Inc., San Jose, CA (US)

(21) Appl. No.: 12/817,358

(22) Filed: Jun. 17, 2010

(51) Int. Cl. G06F 21/00; G06F 3/01

(52) U.S. Cl. 715/753; 726/29; 726/1

(57) ABSTRACT

In one embodiment, a method includes identifying a group and determining an authorization associated with the group. The group includes a plurality of parties, and the authorization is indicative of a privilege level associated with the group. The method also includes obtaining a set of data and processing the set of data. Processing the set of the data includes determining if the authorization indicates that at least a first section of the data is accessible to the group. Finally, the first section of data is rendered for presentation to the group if it is determined that the authorization indicates that the first section of the data is accessible to the group.

### BACKGROUND

The disclosure relates generally to networking, and more particularly to automatically and dynamically altering information presented in a meeting based on privilege levels of attendees of the meetings.

Within collaborative environments, or environments in which information is shared, different parties often have different permissions and/or security levels. For example, one party may have permissions and/or a security level that enables that party to view substantially all the content associated with a document, while another party may have permissions and/or a security level that enables that party to view a lesser amount of content. Thus, it often becomes difficult to share or to otherwise “portray” documents in an environment where the documents are shared, as it is desirable to prevent parties without proper authorization and/or security levels from viewing or otherwise accessing content of the documents, e.g., sensitive content, to which they are not entitled.

Often, in the context of meetings, presentations are made to all attendees at the meeting. A party presenting information that includes sensitive content must attempt to manually identify the pieces of information that may be shared with all attendees, and avoid presenting the sensitive content if not all attendees are authorized to view the sensitive content. When the number of attendees at a meeting is relatively high, and if the amount of information to be presented at the meeting is relatively high, the ability to effectively manage information such that information is substantially only portrayed, e.g., displayed or availed to, those parties with appropriate permissions and/or security levels is becoming increasingly difficult.

### BRIEF DESCRIPTION OF THE DRAWINGS

The disclosure will be readily understood by the following detailed description in conjunction with the accompanying drawings in which:

FIG. 1A is a diagrammatic representation of data, e.g., data to be rendered, that includes portions that are associated with different privileges, e.g., security levels or permissions, in accordance with an embodiment.

FIG. 1B is a diagrammatic representation of data that includes portions that are associated with different privileges, e.g., security levels or permissions, as presented to a user with a lowest security permission in accordance with an embodiment.

FIG. 1C is a diagrammatic representation of data that includes portions that are associated with different privileges, e.g., security levels or permissions, as presented to a user with an intermediate security permission in accordance with an embodiment.

FIG. 1D is a diagrammatic representation of data that includes sections of content that are associated with different privileges, e.g., security levels or permissions, as presented to a user with a highest security permission in accordance with an embodiment.

FIG. 2 is a process flow diagram which illustrates a method of dynamically presenting information in accordance with an embodiment.

FIG. 3 is a diagrammatic representation of an overall system in which privileges of meeting attendees are used to dynamically identify data that substantially all of the meeting attendees have permission to view in accordance with an embodiment.

FIGS. 4A and 4B are a process flow diagram which illustrates a method of dynamically dismissing meeting attendees until substantially all remaining meeting attendees have a particular, e.g., desired, privilege level in accordance with an embodiment.

FIGS. 5A and 5B are a process flow diagram which illustrates a method of handling meeting attendees who do not have a particular, e.g., desired, privilege level when at least some such attendees are not dismissed from the meeting in accordance with an embodiment.

### DESCRIPTION OF EXAMPLE EMBODIMENTS

### General Overview

According to one aspect, a method includes identifying a group and determining an authorization associated with the group. The group includes a plurality of parties, and the authorization is indicative of a privilege level associated with the group. The method also includes obtaining a set of data and processing the set of data. Processing the set of the data includes determining if the authorization indicates that at least a first section of the data is accessible to the group. Finally, the first section of data is rendered for presentation to the group if it is determined that the authorization indicates that the first section of the data is accessible to the group.

### Description

The use of collaborative environments or, more generally, environments, in which resources are shared between multiple parties, is rapidly increasing. Shared resources may generally include data that is presented, for example, in a composition or an instance of content. Compositions may generally include, but are not limited to including, documents, video files, audio files, presentations, blogs, and wikis. Parties which generally have access to shared resources may have different privileges. For example, attendees of a meeting at which data is to be presented may have different privileges, e.g., security levels and/or permissions, with respect to the types of data that they are entitled to view or otherwise access. To protect the confidentiality of information that is to be viewed only by attendees of a meeting with the highest privileges, such information may be prevented from being presented if there are any attendees of the meeting without sufficient privileges to view the information.

Often, attendees are invited to attend a future meeting when a meeting “owner,” e.g., a party initiating a meeting, sends invitations to the meeting or causes invitations to the meeting to be sent. Once invited attendees receive invitations to the meeting, the invited attendees may communicate back to the meeting owner whether they will or will not attend the meeting. A calendaring system may be used by the meeting owner to keep track of meeting attendees, or invited attendees that indicate they will attend the meeting. Many calendaring systems allow the meeting owner to access an entry associated with the meeting to view a list of meeting attendees that are intending to attend, or otherwise participate in, the meeting.

In one embodiment, an application, e.g., a software application, or a device that is to be used to present data at a meeting may access a calendaring system to identify the parties that may be attending a meeting and, thus, identify parties that may be privy to viewing the data at the meeting. Upon identifying the parties, the application or device may compare privilege levels of the parties to the privilege levels associated with the data to effectively select or otherwise identify which portions of data may be presented at the meeting. Generally, substantially only the portions of data that all parties have sufficient privileges to view may be presented at the meeting. If a particular party does not possess a privilege level that allows for viewing all the data, then the application or device may typically present substantially only the portions of data that are appropriate for rendering to all parties, while preventing other portions of data, e.g., portions of data that the particular party does not have sufficient privileges to view, from being rendered to all parties. That is, portions of data that are presented at a meeting are typically portions of data that are associated with a highest common privilege level between all parties involved with the meeting and are, therefore, proper for viewing by those parties.

Adjustments to data presented at a meeting may be made dynamically. That is, the data that is presented at a meeting may be adjusted dynamically, e.g., substantially in real-time, such that the data presented remains consistent with the authorizations of parties viewing the data at a present time. By way of example, as parties join and/or leave a meeting, the data presented at the meeting may be dynamically modified as appropriate to ensure that all parties in the meeting have sufficient authorization, e.g., privilege levels, to view the presented data. Hence, as a representative privilege level associated with the parties in the meeting changes, data presented to the parties may be dynamically changed such that the data presented remains appropriate for the parties. It should be appreciated that although a representative privilege level may be a highest common privilege level, the representative privilege level is not limited to being the highest common privilege level.

In order to identify portions of data that a party is authorized to view based on a privilege level of the party, data may be substantially separated into discrete units that are at least partly identified by the privileges needed to view, or otherwise access, the discrete units. As such, an amalgamation or set of data, e.g., a document, may effectively be an aggregation of discrete blocks or units of content. A party may view or otherwise access only the discrete blocks of data that his privilege level allows him to access. A party with a relatively high privilege level may be able to view or otherwise access an entire set of data, or substantially all content associated with the set of data. On the other hand, a user with a relatively low privilege level may be substantially restricted from viewing much of the content associated with the set of data.

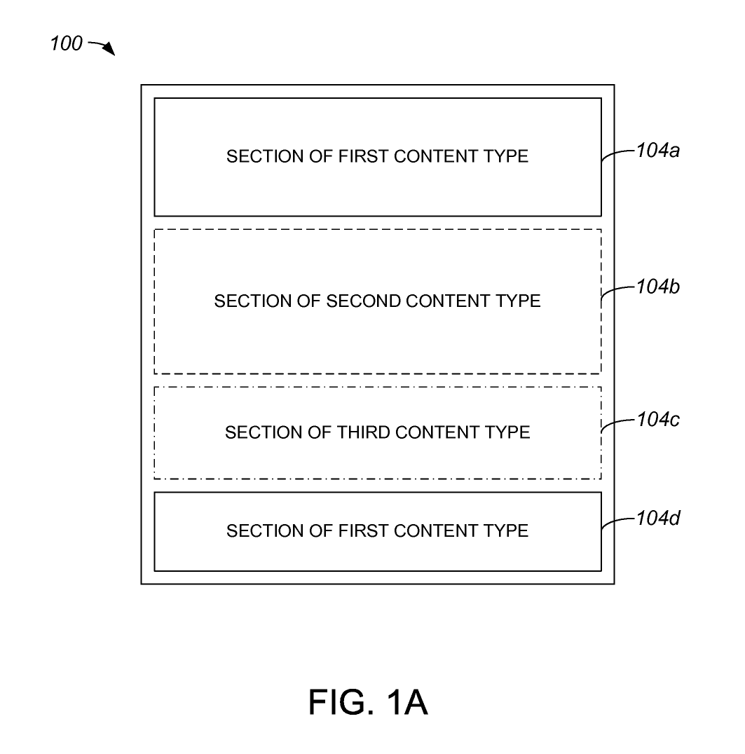

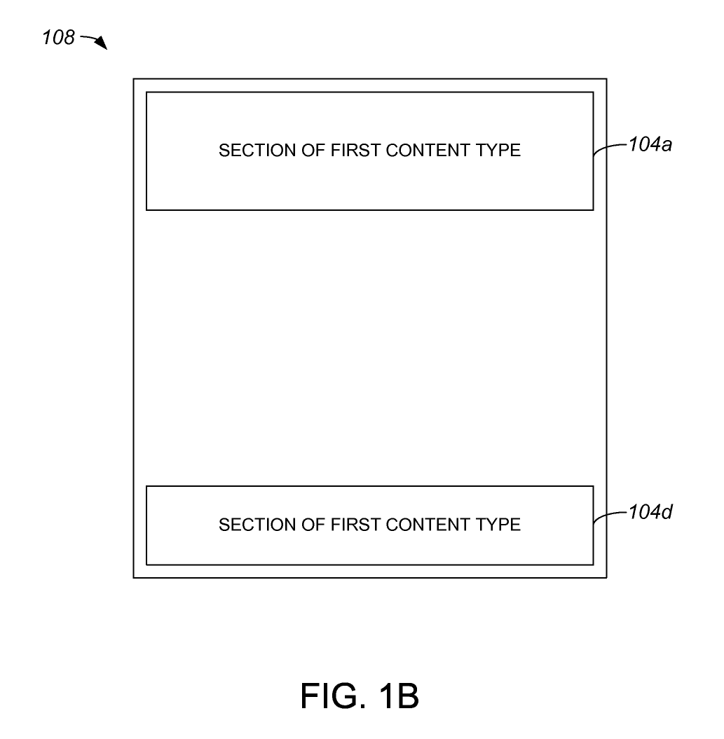

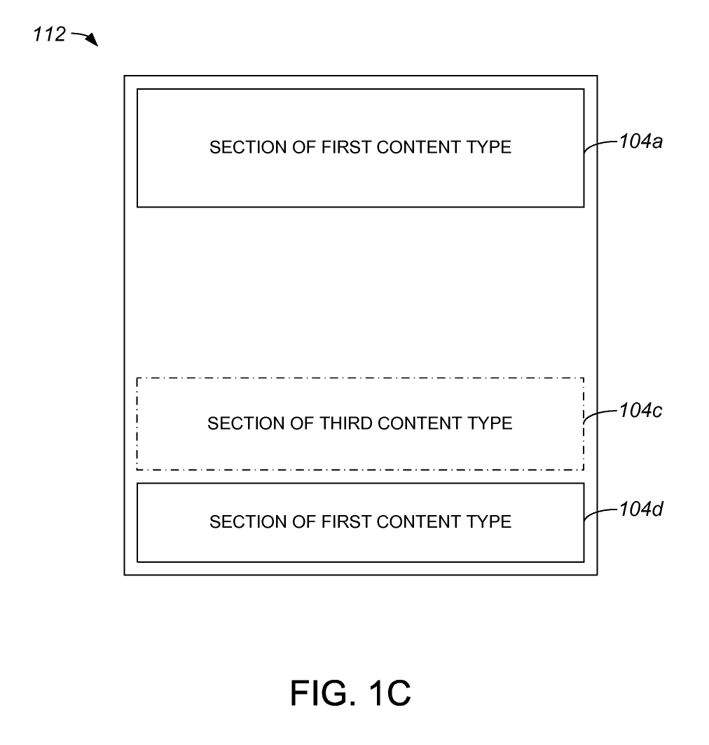

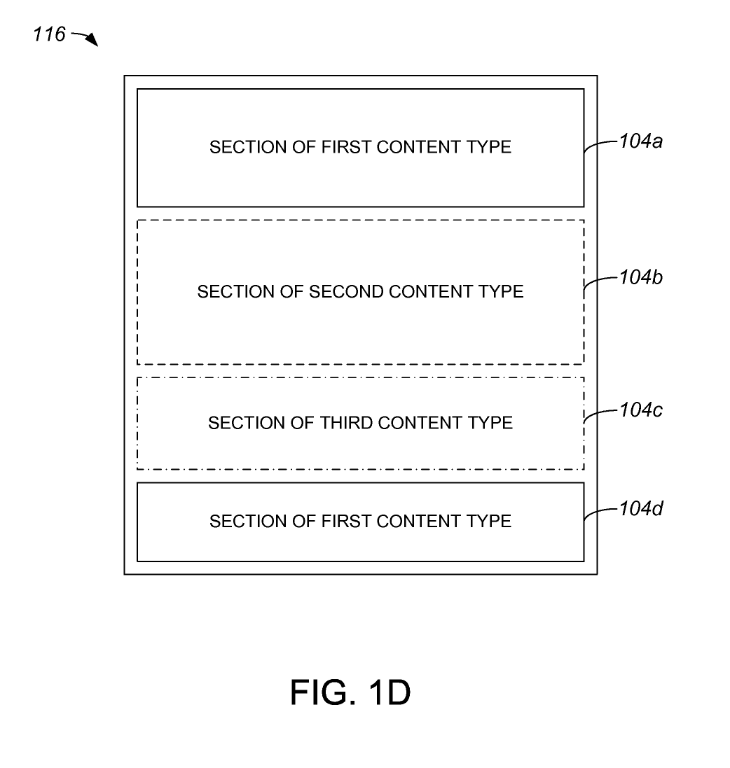

With reference to FIGS. 1A-D, one example of a set of data which is effectively parsed or otherwise divided into discrete units based on associated permissions and/or security levels will be described. Referring initially to FIG. 1A, a diagrammatic representation of a set of data that includes sections of content associated with different privileges will be described in accordance with an embodiment. A set of data 100, which may be a document, includes two sections of a first content type 104a, 104d, as well as a section of a second content type 104b and a section of a third content type 104c. Set of data 100 is effectively an aggregate of sections 104a-d.

It should be appreciated that set of data 100 may generally include any number of sections and any number of content types. The number of sections and the number of content types illustrated in FIG. 1A is shown purely for ease of discussion. Data 100 may be arranged as a document that is to be rendered or otherwise presented in a meeting.

In one embodiment, sections of the first content type 104a, 104d may be viewable, or otherwise accessed, by users having substantially any privileges, e.g., permissions and/or security level. That is, even users with the most restrictive privilege levels are substantially authorized to view or otherwise access sections 104a, 104d. Section of the second content type 104b may be viewable, or otherwise accessed, substantially only by users having a highest privilege level, e.g., the least restrictive permissions and/or highest security level. Section of third content type 104c may be viewable, or otherwise accessed, by users with any privilege level which is less restrictive than the most restrictive privilege levels and/or any security level that is higher than the lowest security level.

Sections 104a-d may include visual aspects that are arranged to indicate the privilege levels associated with sections 104a-d, respectively. That is, visual indicators may be included in sections 104a-d such that a viewer of data 100 may readily identify privilege levels associated with each of sections 104a-d.

FIG. 1B is a diagrammatic representation of data 100 of FIG. 1A as presented to a user with the lowest privilege level, e.g., the most restrictive permissions and lowest security level, associated with data 100 in accordance with an embodiment. A representation 108 includes sections of the first content type 104a, 104b, as sections of the first content type 104a, 104b are associated with the lowest privilege level. Thus, when data 100 of FIG. 1A is essentially presented to a user with the lowest privilege level, representation 108 is displayed. Therefore, the user with the most restrictive permissions and/or the lowest security level is presented with representation 108 when he or she requests access to document 100 of FIG. 1A, and content that such a user is not authorized to view is not presented to the user.

It should be appreciated that representation 108 may optionally include an indication (not shown) configured to indicate that some data 100, as portrayed in FIG. 1A, is omitted from representation 108. Such an indication (not shown) may be, but is not limited to being, a visual indication such as a darkened area which replaces content that is not included in representation 108 or a visual indication such as text which effectively states that some content has been omitted.

When a user with a higher privilege level than the lowest privilege level requests access to data 100 of FIG. 1A, that user is presented with a representation 112 of data 100, as shown in FIG. 1C. Representation 112 includes sections of the first content type 104a, 104b and section of the third content type 104c. Section of the third content type 104c is viewable to any user with a higher privilege level than the lowest privilege level. In the embodiment as shown, a user with a mid-level privilege level is presented with section of the third content type 104c because section of the third content type 104c is generally viewable by any user with a privilege level that is higher than the lowest privilege level.

As previously mentioned, section of the second content type 104b of FIG. 1A is viewable by or otherwise accessible to substantially only users with the highest privilege level. FIG. 1D is a diagrammatic representation of a rendering 116 of data 100 of FIG. 1A as presented to a user with the highest privilege level in accordance with an embodiment. A user with the highest privilege level may have, in one embodiment, the authorization to view or otherwise access substantially all of data 100 of FIG. 1A. Rendering 116 includes substantially all viewable section of data 100 of FIG. 1A. As shown, rendering 116 includes sections of the first content type 104a, 104b, in addition to section of third content type 104c and section of the second content type 104b.

When data is to be presented in a meeting, e.g., as a part of a multi-media presentation displayed on a screen to attendees of the meeting, it is desirable to present as much data as possible while ensuring that none of the attendees is viewing data that they do not have privileges to view. That is, data that is presented to a group of meeting attendees is screened to ensure that substantially all meeting attendees are authorized to view the data presented, or that the data presented is appropriate for viewing by the meeting attendee with the lowest privilege level.

An element, e.g., an application such as a software application that is configured to render data, may obtain or otherwise access information relating to parties who are slated to attend, or are already attending, a meeting at which a set of data may be presented. The information, which may be obtained from a calendaring system or server, may be used by the element to identify appropriate portions of the set of data to present in the meeting. In general, information relating to privilege levels of the attendees may be used to dynamically determine which portions of the set of data to present in the meeting such that none of the attendees views data that he/she is not entitled to view.

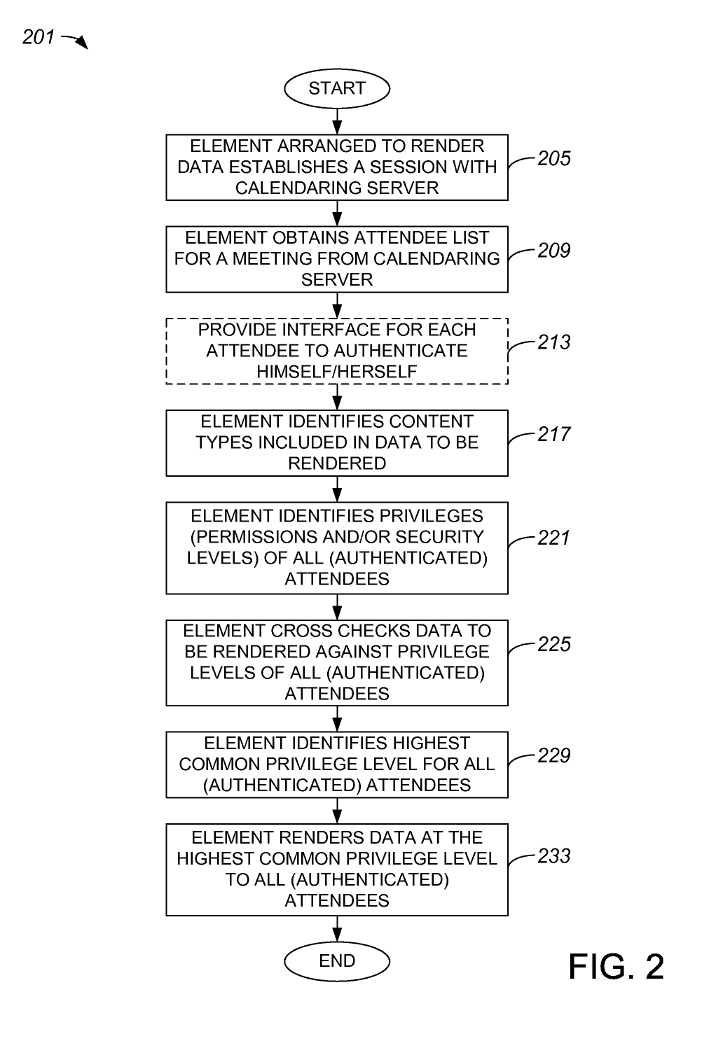

FIG. 2 is a process flow diagram which illustrates a process of dynamically presenting data in accordance with an embodiment. A process 201 of dynamically presenting data begins at step 205 in which an element that is arranged to render data establishes a session with a calendaring server. The element arranged to render data may generally be, but is not limited to being, a device or a software application executing on a computing system. The calendaring server may be any suitable system on which information relating to a meeting may be maintained.

After the element establishes the session with the calendaring server, the element obtains an attendee list for a meeting from the calendaring server in step 209. If the meeting is scheduled in the future, the attendee list may be a list of parties intending to participate in the meeting. If the meeting is a current meeting, e.g., has already begun, the attendee list may effectively be a list of parties already participating in the meeting.

From step 209, process flow may proceed to an optional step 213 or proceed directly to step 217. In optional step 213, an interface may be provided, as for example by the element, that allows each attendee listed on the attendee list to authenticate himself/herself. Attendees may be prompted to authenticate themselves at the beginning of a meeting. The interface provided for authentication purposes may be, but is not limited to being, a web page for the meeting or an interface which utilizes voice recognition, a badge reader arranged to obtain information from badges associated with attendees, and/or RFID readers.

In step 217, the element identifies content types included in the data to be rendered, e.g., presented or displayed in the meeting. Identifying content types generally includes identifying privilege levels associated with different portions of the data. That is, identifying content types typically includes identifying content types of different portions of the data, and determining the lowest privilege level needed by an attendee in order to view or otherwise access each portion. Once the element identifies content types included in the data to be rendered, the element identifies privileges associated with all attendees of the meeting in step 221. It should be appreciated if attendees authenticated themselves in step 213, then the element identifies privileges associated with all authenticated attendees of the meeting. The privilege levels, or authorizations, of substantially all attendees may be identified using the attendee list. The privilege levels may be included in the attendee list, or may be obtained, e.g., from a database, using information provided in the attendee list. In one embodiment, an unauthenticated attendee may be considered to be a “guest” with little or no authorization to view data.

After the element identifies the privilege levels of substantially all attendees, the element cross checks the data to be rendered against the privilege levels or rights of substantially all attendees in step 225. The element may effectively take an inventory of the data to be rendered and compares the content types included in the data against the privilege levels of substantially all attendees. Then, in step 229, the element identifies the highest common privilege level for substantially all attendees. From step 229, process flow moves to step 233 in which the element renders the data to be presented in a manner that is consistent with the highest common privilege level associated with substantially all attendees. In one embodiment, the element renders portions of data that are associated with the highest common privilege level, and prevents any portions of data that are associated with higher privilege levels from being rendered. Upon rendering data, the process of dynamically presenting data is completed.

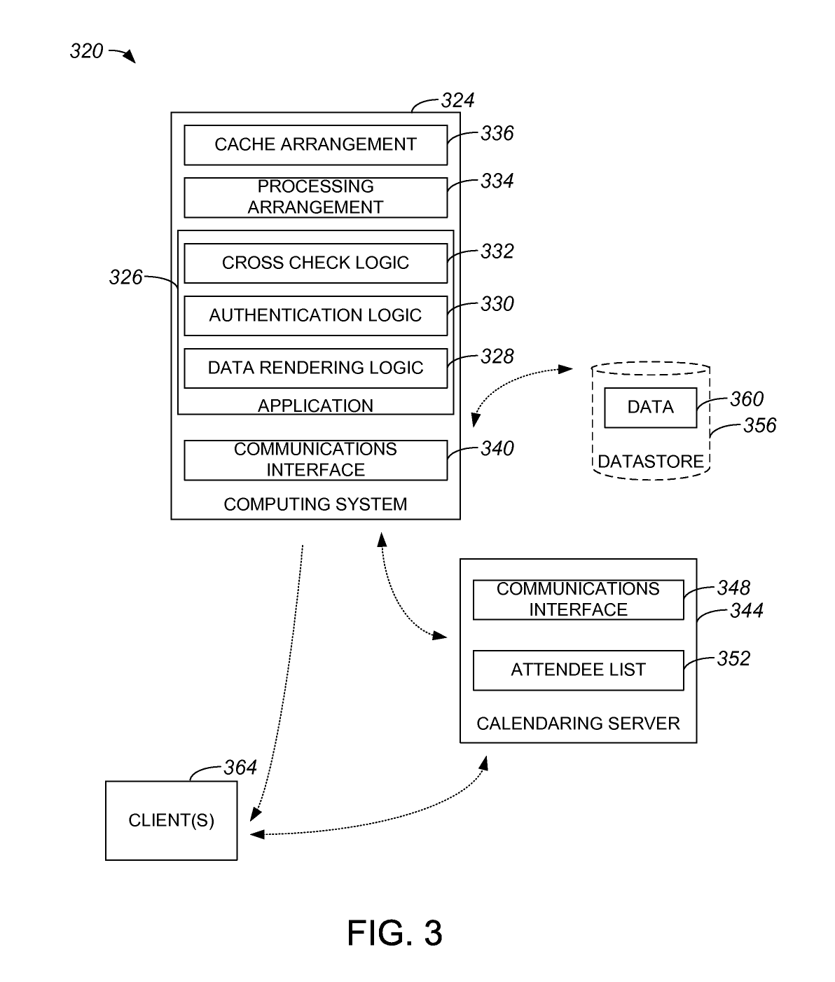

FIG. 3 is a diagrammatic representation of an overall system in which privileges of meeting attendees are used to dynamically identify data that substantially all of the meeting attendees have permission to view in accordance with an embodiment. An overall system 320 is configured to support displaying data to users, e.g., meeting attendees, based upon a highest common privilege level among the users. In other words, overall system 320 is arranged to identify sections of data 360 that are suitable for viewing by users with a particular privilege level, and to render such sections as appropriate.

Overall system 320 may be a distributed system, with various components of overall system 320 being at different locations within a network. It should be appreciated, however, that overall system 320 is not limited to being a distributed system. By way of example, overall system 320 may be embodied on a single computing arrangement. That is, in lieu of being distributed across a network, a computing system 324, a calendaring server 344, a datastore 356, and a client 364 may be a single computing arrangement.

Computing system 324, which may be an access permission server, is generally configured to apply policies to determine what data 360 may be rendered, as for example during a meeting. Computing system is arranged to process information relating to privilege levels such that appropriate data 360 that may be presented to at least one client 364 may be identified and rendered for the benefit of client 364. Computing system 324 generally includes an application 326, a processing arrangement 334, a cache arrangement 336, and a communications interface 340.

Application 326, which may be embodied as hardware and/or software logic, includes data rendering logic 328, authentication logic 330, and cross check logic 332. Data rendering logic 328 is configured to process data 360 obtained from data store 356 for rendering. In one embodiment, data rendering logic 328 processes data 360 such that data 360 may be presented or otherwise provided to client 364 during a meeting.

Authentication logic 330 is configured to provide an interface that enables client 364, e.g., a meeting attendee, to authenticate himself or herself. In one embodiment, authentication logic 330 may provide a web page for a meeting that client 364 may access for authentication purposes. Authentication logic 330 is arranged to identify client 364 as being a meeting attendee through accessing an attendee list 352 maintained by calendaring server 344.

Cross check logic 332 is configured to process an attendee list 352 to identify privilege levels associated with meeting attendees identified in attendee list 352. Once privilege levels of meeting attendees are identified, cross check logic 332 may determine a highest common privilege level among the meeting attendees. Cross check logic 332 is also configured to include policies which may be applied to identify the sections of data 360 which are appropriate for rendering to meeting attendees such as client 364 based upon factors including, but not limited to including, the highest common privilege level among the meeting attendees.

In one embodiment, cross check logic 332 may cause meeting attendees identified in attendee list 352 that do not meet a desired privilege level to be dismissed from a meeting. Cross check logic 332 may further provide cues, e.g., visual and/or audio cues, to an owner or administrator of a meeting to essentially notify the owner or administrator when meeting attendees are effectively dismissed from the meeting. It should be appreciated that the owner or administrator of a meeting, or even some other attendee of the meeting, may dynamically alter the rights of other attendees of the meeting. For example, cross check logic 332 may provide an option to permanently or temporarily override a privilege level of a particular attendee to enable the particular attendee to remain in the meeting.

Processing arrangement 334 is configured to execute logic associated with application 326. By way of example, when application 326 is embodied on a tangible media as computer code, processing arrangement 334 may execute the computer code to effectively cause computing system 340 to perform a method of causing data 360 that is appropriate to a particular privilege level to be rendered.

Cache arrangement 336 is configured to store attendee list 352 when attendee list 352 is obtained from calendaring server 344. It should be appreciated that although cache arrangement 336 is shown as being included in computing system 324, cache arrangement 336 is not limited to being included in computing system 324. For example, cache arrangement 336 may be remote to computing system 324 and may be accessible through communications interface 340.

Communications interface 340, which may generally include input and output ports, allows computing system 324 to communicate with calendaring server 344, data store 356, and client 364. Communications interface 340 may be configured to communicate through physical communications links and/or wireless communications links. Data 360 and attendee list 352 may be obtained by computing system 324 for use by application 326 through communications interface 340.

Calendaring server 344 includes a communications interface 348 that allows calendaring server 344 to communicate within overall system 324. Calendaring server 344 is generally arranged to facilitate the set-up of meetings and to maintain information relating to meetings. For each meeting that is set-up using calendaring server 344, an attendee list 352 which provides information relating to attendees of the meeting may be maintained. In the described embodiment, client 364 may be identified in attendee list 352 as a meeting attendee.

Datastore 356 is configured to maintain data 360. It should be appreciated that although datastore 356 is shown as being substantially separate from but accessible by computing system 324, datastore 356 may instead be included as a part of computing system 324. Data 360 may include any data that is to be rendered, e.g., rendered for presentation at a meeting. In one embodiment, data 360 may be stored such that a minimum privilege level needed to view each portion of data 360 may be identified. It should be appreciated that data 360 is not limited to being maintained on datastore 356. That is, datastore 356 may be optional, as for example if data 360 is “live” or otherwise provided substantially in real-time from an input source (not shown).

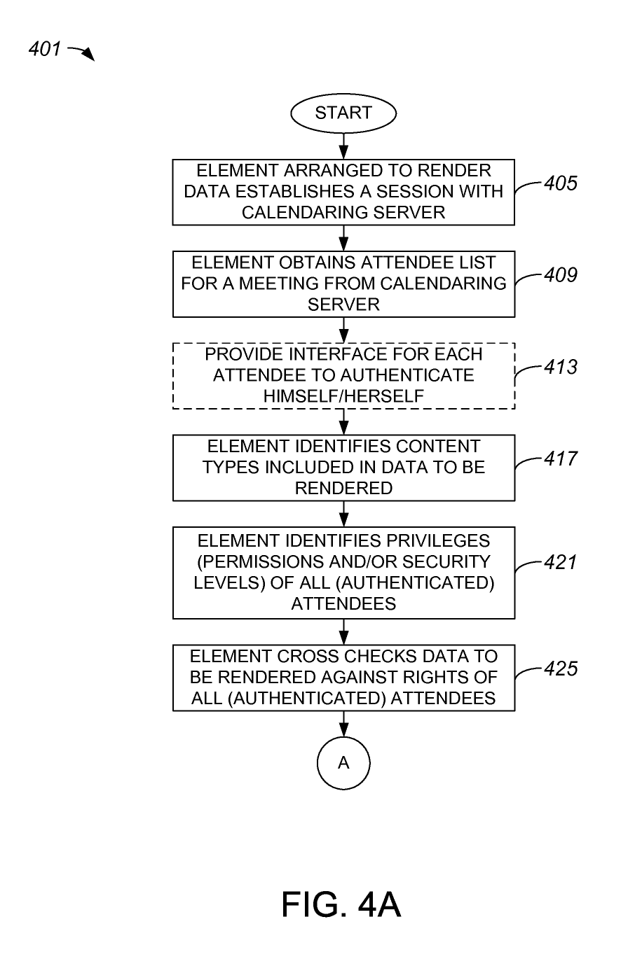

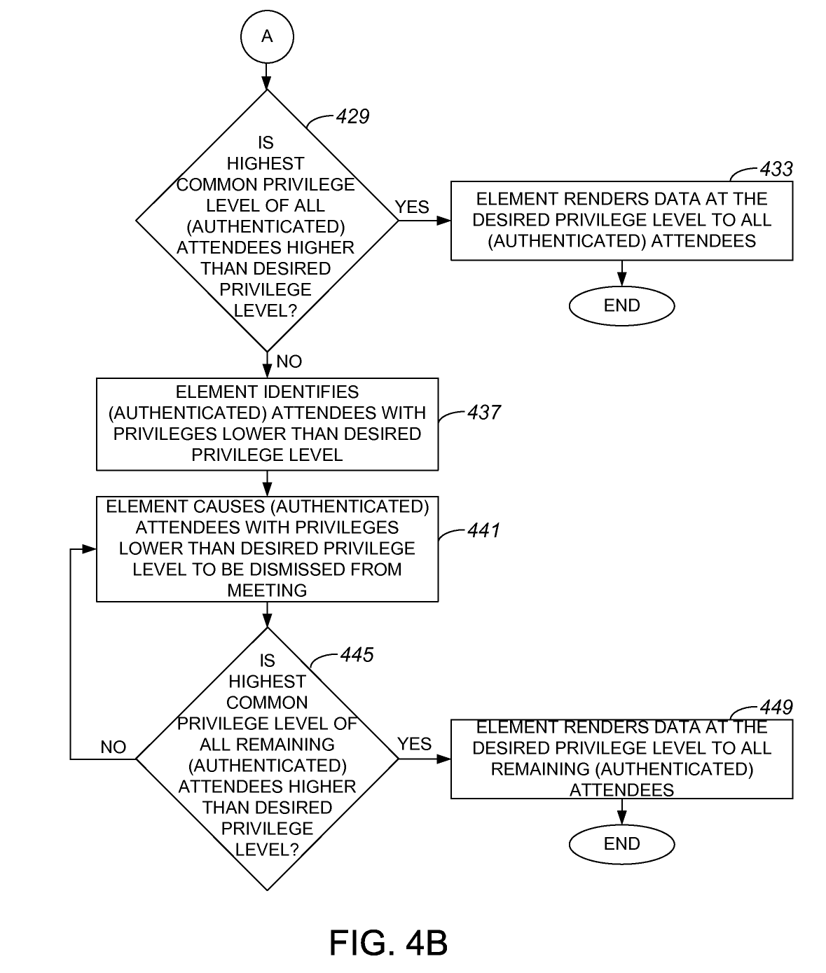

In one embodiment, a meeting may be such that only attendees with a particular privilege level or a privilege level that is higher than the particular privilege level may view rendered data. That is, a meeting may be such that substantially all meeting attendees are expected to meet a particular privilege level. If attendees essentially need at least a particular privilege level to attend a meeting, then attendees who do not have at least the particular privilege level may effectively be dismissed from the meeting. With reference to FIGS. 4A and 4B, a method of dynamically dismissing meeting attendees until substantially all remaining meeting attendees have a particular, e.g., desired, privilege level will be described in accordance with an embodiment. A process 401 of dynamically dismissing meeting attendees begins at step 405 in which an element that is arranged to render data establishes a session with a calendaring server. Upon establishing the session with the calendaring server, the element obtains an attendee list for a meeting from the calendaring server in step 409.

After an attendee list is obtained in step 409, process flow may either proceed to an optional step 413 or proceed directly to step 417. In optional step 413, an interface may be provided, as for example by the element, that allows each attendee listed on the attendee list to authenticate himself/herself.

In step 417, the element identifies content types included in the data to be rendered, e.g., presented or displayed in the meeting. Identifying content types generally includes identifying privilege levels associated with different portions of the data. That is, identifying content types typically includes identifying content types of different portions of the data, and determining the lowest privilege level needed by an attendee in order to view or otherwise access each portion. Once the element identifies content types included in the data to be rendered, the element identifies privileges associated with all attendees of the meeting in step 421. It should be appreciated if attendees authenticated themselves in step 413, then the element identifies privileges associated with all authenticated attendees of the meeting.

After the element identifies the privilege levels of substantially all attendees in step 421, the element cross checks the data to be rendered against the privilege levels or rights of substantially all attendees in step 425. The element may effectively take an inventory of the data to be rendered and compares the content types included in the data against the privilege levels of substantially all attendees.

A determination is made in step 429 as to whether the highest common privilege level of substantially all attendees is higher than a desired privilege level. The desired privilege level may be arranged to indicate a minimum privilege level that an attendee is expected to have if the attendee is to view the data rendered at the meeting. If the determination in step 429 is that the highest common privilege level of substantially all attendees is higher than the desired privilege level, then the indication is that substantially all attendees have sufficient privileges to view the data. As such, process flow moves to step 433 in which the element renders data at the desired privilege level to substantially all attendees, and the process of dynamically dismissing meeting attendees is completed.

Alternatively, if the determination in step 429 is that the highest common privilege level of substantially all attendees is not higher than the desired privilege level, then the implication is that at least one attendee has a privilege level that is lower than the highest common privilege level. Accordingly, in step 437, the element identifies those attendees with privilege levels that are lower than the desired privilege level. Once the attendees with privilege levels lower than the desired privilege level are identified, those attendees are dismissed from the meeting in step 441. Dismissing the attendees with privilege levels lower than the desired privilege level may include, but is not limited to including, prompting those attendees to withdraw from the meeting or otherwise causing those attendees to be automatically dropped from the meeting.

It is determined in step 445 whether the highest common privilege level of all remaining attendees is higher than the desired privilege level. If it is determined that the highest common privilege level of all remaining attendees is not higher than the desired privilege level, the indication is that at least one attendee with a privilege level that is lower than the highest common privilege level has not been dismissed. As such, process flow returns to step 441 in which any remaining attendees with a privilege level that is lower than the highest common privilege level may be dismissed from the meeting. The dismissal of any remaining attendees may occur, in one embodiment, as a part of a verification process that verifies the privilege levels of the remaining attendees. Such a verification process may be substantially automatic, or may be at the option of a host.

Alternatively, if it is determined in step 455 that the highest common privilege level of all remaining attendees is higher than the desired privilege level, then process flow moves to step 449 in which the element renders the data to be presented in a manner that is consistent with the desired privilege level. Upon rendering data, the process of dynamically dismissing attendees that do not have at least a desired privilege level is completed.

In some situations, an attendee who does not have at least a desired privilege level may effectively fail to be dismissed from a meeting. By way of example, such an attendee may be unable to dismiss himself or herself, or to otherwise bow out of a meeting, prior to the meeting occurring. A variety of different methods may be used to address an attendee who does not have at least a desired privilege level and is not dismissed from a meeting at which attendees are expected to have at least the desired privilege level. By way of example, the meeting may be cancelled and a new meeting, which does not include any attendees that do not have at least a desired privilege level, may be scheduled. Alternatively, data that is to be presented at the meeting, e.g., a virtual meeting, may be substantially screened such that attendees that do not have at least a desired privilege level may not view any data that has a relatively high privilege level, e.g., a privilege level that is higher than the desired privilege level. In other words, data may be substantially censored such that certain attendees are effectively excluded from viewing certain sections of data.

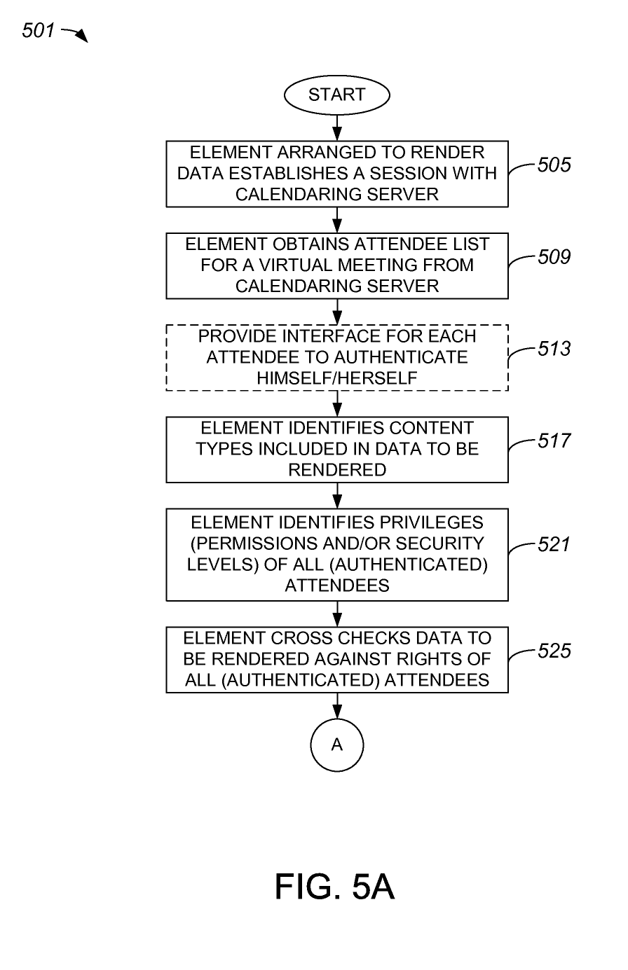

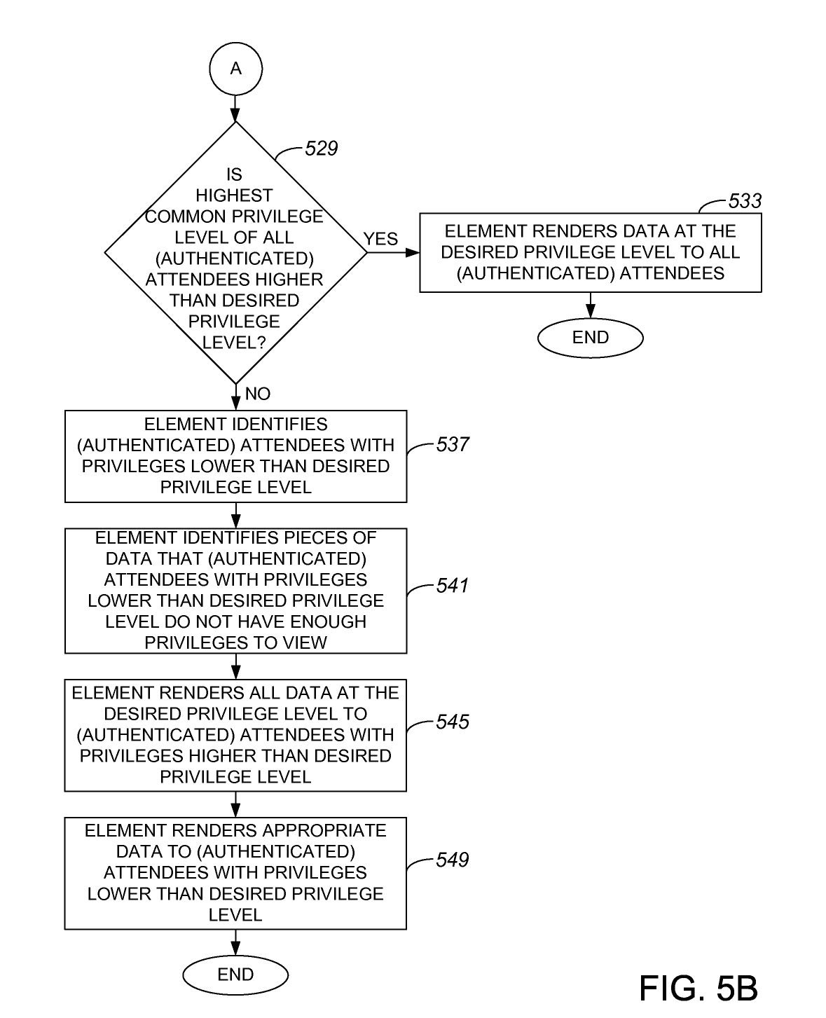

With reference to FIGS. 5A and 5B, a method of handling meeting attendees who do not have a particular, e.g., desired, privilege level by substantially censoring the data presented to those meeting attendees will be described in accordance with an embodiment. A process 501 of censoring data presented to meeting attendees with insufficient privilege levels begins at step 505 in which an element that is arranged to render data establishes a session with a calendaring server. Once the session with the calendaring server is established, the element obtains an attendee list for a meeting from the calendaring server in step 509.

After an attendee list is obtained in step 509, process flow may either proceed to an optional step 513 or proceed directly to step 517. In optional step 513, an interface may be provided, as for example by the element, that allows each attendee listed on the attendee list to authenticate himself/herself.

In step 517, the element identifies content types included in the data to be rendered, e.g., presented or displayed in the meeting. Identifying content types generally includes identifying privilege levels associated with different portions of the data. That is, identifying content types typically includes identifying content types of different portions of the data, and determining the lowest privilege level needed by an attendee in order to view or otherwise access each portion. Once the element identifies content types included in the data to be rendered, the element identifies privileges associated with all attendees of the meeting in step 521. It should be appreciated if attendees authenticated themselves in step 513, then the element identifies privileges associated with all authenticated attendees of the meeting.

Upon identifying the privilege levels of substantially all attendees in step 521, the element cross checks the data to be rendered against the privilege levels or rights of substantially all attendees in step 525. The element may effectively take an inventory of the data to be rendered and compares the content types included in the data against the privilege levels of substantially all attendees.

It is determined in step 529 whether the highest common privilege level of substantially all attendees is higher than a desired privilege level. The desired privilege level may be arranged to indicate a minimum privilege level that an attendee is expected to have if the attendee is to view the data rendered at the meeting. If the determination in step 529 is that the highest common privilege level of substantially all attendees is higher than the desired privilege level, then the indication is that substantially all attendees have sufficient privileges to view the data. As such, process flow moves to step 533 in which the element renders data at the desired privilege level to substantially all attendees, and the process of censoring data presented to meeting attendees with insufficient privilege levels is completed.

On the other hand, if it is determined in step 529 that the highest common privilege level of substantially all attendees is not higher than the desired privilege level, the implication is that at least one attendee has a privilege level that is lower than the highest common privilege level. As such, process flow moves from step 529 to step 537 in which the element identifies those attendees with privilege levels that are lower than the desired privilege level.

After the attendees with privilege levels lower than the desired privilege level are identified, the element identifies pieces or portions of data in step 541 that attendees with privileges lower than the desired privilege level may not view or otherwise access. In general, the element identifies portion of data that are substantially consistent with the desired privilege level, e.g., that may be viewed by attendees with at least the desired privilege level.

Once the element identifies pieces of data in step 541, process flow proceeds to step 545 in which the element renders, e.g., presents, substantially all data that is consistent with the desired privilege level to attendees with a privilege level that is equal to or higher than the desired privilege level. Then, in step 549, the element renders appropriate data to attendees with privilege levels that are lower than the desired privilege level, i.e., insufficient privilege levels. It should be appreciated that rendering appropriate data may include, but is not limited to including, presenting data that is consistent with a lower than desired privilege level to those attendees, as well as blocking access to data that is associated with the desired privilege level or higher privilege levels. That is, data is effectively censored. Blocking access to data may include, in the context of a virtual meeting, blacking out screens and/or audio on computing systems of attendees with lower than desired privilege levels whenever data that is consistent with the desired privilege level or a higher privilege level is presented. The process of censoring data presented to meeting attendees with insufficient privilege levels is completed after the element renders appropriate data to attendees with privileges lower than the desired privilege level.

Although only a few embodiments have been described in this disclosure, it should be understood that the disclosure may be embodied in many other specific forms without departing from the spirit or the scope of the present disclosure. By way of example, a calendaring system has generally been described as being maintained on a calendaring server that is substantially separate from an application or device that is arranged to render data that may be presented at a meeting. In general, however, a calendaring system is not limited to being maintained on a separate calendaring server. A calendaring system in some instances, may be maintained as a part of an application or device that is arranged to render data that may be presented at a meeting.

While sections of content type have been described as being relatively distinct, e.g., as shown in FIGS. 1A-D, it should be appreciated that sections of content may also be substantially embedded within other sections of content. That is, sections of content type are not limited to being distinct, as content with one privilege or security level may be substantially embedded within another section of content that has a different privilege or security level. In general, content may be divided substantially granularly based open security levels associated with the content.

When a calendaring system is accessed by an application to effectively obtain a list of meeting attendees, information relating to the privilege levels of the attendees may also be obtained. It should be appreciated, however, that the privilege levels of the attendees may instead be obtained from other sources. By way of example, upon obtaining a list of meeting attendees from a calendaring system, an application my access a database to obtain the privilege levels. In other words, if a calendaring system is not arranged to store privilege levels associated with meeting attendees, the privilege levels may be obtained from other sources once the meeting attendees are identified.

Generally, the data presented in a meeting may be dynamically altered as the attendees of the meeting change. In other words, as attendees are logged as being present at a meeting and leaving the meeting, the data presented may be adjusted. For instance, if the attendee with the lowest privilege level associated with a meeting leaves the meeting or is otherwise no longer identified as attending the meeting, then data presented at the meeting is no longer constrained to be consistent with the lowest privilege level. Hence, a different representative, e.g., highest common, privilege level may be associated with the attendees. As such, data associated with a higher privilege level may then be presented. Typically, the data presented at a meeting may be dynamically adjusted to remain consistent with the lowest privilege level associated with any of the attendees of the meeting.

In one embodiment, an owner or administrator of a meeting may be informed by a suitable application that not all attendees of the meeting have privileges sufficient to allow substantially all data to be presented at the meeting. Upon being informed, the owner or administrator may undertake to allow all attendees of the meeting to view the data. For example, after being informed that not all attendees of a meeting have privileges sufficient to allow substantially all data to be presented at a meeting, an owner or administrator may make an informed decision as to whether to move forward and allow substantially all data to be presented by effectively temporarily grant higher privileges to the attendees of the meeting as appropriate.

While meeting attendees have generally been described as each having a privilege level, it should be appreciated that each meeting attendee may generally have more than one privilege level. For instance, a meeting attendee may have one privilege level for a one type of meeting, and a different privilege level for a different type of meeting. Further, a meeting attendee may have different privilege levels depending upon who is present at a meeting. By way of example, a meeting attendee may have a one privilege level if he/she is in a meeting with one particular party, and may have another privilege level if he/she is in a meeting with another party.

Although data has generally been described as being rendered at a highest common privilege level associated with a group of meeting attendees, it should be appreciated that a system is not limited to rendering data at the highest common privilege level. For example, data may be rendered at a higher privilege level or a lower privilege level at the discretion of an owner or administrator of the meeting. In other words, when provided with data rendered with respect to one privilege level, an owner of a meeting may make a decision to select a different privilege level at which to render the data.

The embodiments may be implemented as hardware and/or software logic embodied in a tangible medium that, when executed, is operable to perform the various methods and processes described above. That is, the logic may be embodied as physical arrangements or components. A tangible medium may be substantially any computer-readable medium that is capable of storing logic which may be executed, e.g., by a computing system, to perform methods and functions associated with the embodiments. Such computer-readable mediums may include, but are not limited to including, physical storage or memory devices. Executable logic may include code devices, computer program code, and/or executable computer commands or instructions. In general, the devices and arrangements associated with the present disclosure may include hardware and/or software logic.

The steps associated with the methods of the present disclosure may vary widely. Steps may be added, removed, altered, combined, and reordered without departing from the spirit of the scope of the present disclosure. By way of example, the privilege levels of meeting attendees may be dynamically checked during the course of a meeting. Checking the privilege levels while a meeting is ongoing may allow adjustments to be made to rendered data if the privilege level of a particular attendee changes while the meeting is ongoing. Therefore, the present examples are to be considered as illustrative and not restrictive, and the examples is not to be limited to the details given herein, but may be modified within the scope of the appended claims.

What is claimed is:

1. A method comprising:
identifying a group, the group including a plurality of parties;
determining an authorization associated with the group, the authorization being indicative of a privilege level associated with the group;
obtaining a set of data;
processing the set of data, wherein processing the set of the data includes determining if the authorization indicates that at least a first section of the data is accessible to the group; and
rendering the at least first section of the data for presentation to the group if it is determined that the authorization indicates that the at least first section of the data is accessible to the group.

2. The method of claim 1 wherein the authorization indicates that the at least first section of the data is accessible to the group when the privilege level meets or exceeds a particular privilege level.

3. The method of claim 2 wherein the privilege level associated with the group is a highest common privilege level associated with the group and the authorization is indicative of the highest common privilege level, and wherein each party of the plurality of parties possesses the highest common privilege level.

4. The method of claim 3 wherein if the highest common privilege level does not meet or exceed the particular privilege level, at least some parties of the plurality of parties are dismissed from the group.

5. The method of claim 2 wherein the particular privilege level is associated with the at least one section of data.

6. The method of claim 1 wherein identifying the group includes accessing a calendaring system and obtaining a list from the calendaring system, the list being configured to identify the group.

7. The method of claim 6 wherein the list identifies the group as being attendees of a meeting, and wherein the at least first section of the data is arranged to be presented to the attendees of the meeting.

8. The method of claim 7 wherein the meeting is a virtual meeting.

9. The method of claim 1 further including:
determining if the privilege level meets or exceeds the particular privilege level; and
if it is determined if the privilege level does not meet or exceed the particular privilege level,
identifying a first party of the plurality of parties, the first party having a first privilege level, the first privilege level being less than the particular privilege level, and
dismissing the first party from the group, wherein dismissing the first party from the group causes the privilege level to meet or exceed the particular privilege level.

10. The method of claim 1 further including:
determining if the privilege level meets or exceeds the particular privilege level; and
if it is determined if the privilege level does not meet or exceed the particular privilege level,
identifying a first party of the plurality of parties, the first party having a first privilege level, the first privilege level being less than the particular privilege level, and
censoring the first party, wherein censoring the first party causes the at least one section of the data to be presented to at least one party of the plurality of parties but not to the first party.

11. The method of claim 1 wherein rendering the at least first section of the data for presentation to the group if the privilege level meets or exceeds the particular privilege level includes rendering the at least first section of the data for presentation to the group in a meeting attended by the group.

12. A computer-readable medium comprising computer program code, the computer program code, when executed, configured to:
identify a group, the group including a plurality of parties;
determine an authorization associated with the group, the authorization being indicative of a privilege level associated with the group;
obtain a set of data;
process the set of data, wherein the computer program code configured to process the set of the data is configured to determine if the authorization indicates that at least a first section of the data is accessible to the group; and
render the at least first section of the data for presentation to the group if it is determined that the authorization indicates that the at least first section of the data is accessible to the group.

13. The computer-readable medium of claim 12 wherein the authorization indicates that the at least first section of the data is accessible to the group when the privilege level meets or exceeds a particular privilege level.

14. The computer-readable medium of claim 13 wherein the privilege level associated with the group is a highest common privilege level associated with the group and the authorization is indicative of the highest common privilege level, and wherein each party of the plurality of parties possesses the highest common privilege level.

15. The computer-readable medium of claim 14 wherein if the highest common privilege level does not meet or exceed the particular privilege level, at least some parties of the plurality of parties are dismissed from the group.

16. The computer-readable medium of claim 13 wherein the particular privilege level is associated with the at least one section of data.

17. The computer-readable medium of claim 12 wherein the computer code configured to identify the group is further configured to access a calendaring system and to obtain a list from the calendaring system, the list being configured to identify the group.

18. The computer-readable medium of claim 17 wherein the list identifies the group as being attendees of a meeting, and wherein the at least first section of the data is arranged to be presented to the attendees of the meeting.

19. The computer-readable medium of claim 18 wherein the meeting is a virtual meeting.

20. The computer-readable medium of claim 12 wherein the computer program code is further configured to:
determine if the privilege level meets or exceeds the particular privilege level; and
if it is determined if the privilege level does not meet or exceed the particular privilege level,
identify a first party of the plurality of parties, the first party having a first privilege level, the first privilege level being less than the particular privilege level, and
dismiss the first party from the group, wherein the computer code configured to dismiss the first party from the group causes the privilege level to meet or exceed the particular privilege level.

21. The computer-readable medium of claim 12 wherein the computer program code is further configured to:
determine if the privilege level meets or exceeds the particular privilege level; and
if it is determined if the privilege level does not meet or exceed the particular privilege level,
identify a first party of the plurality of parties, the first party having a first privilege level, the first privilege level being less than the particular privilege level, and
censor the first party, wherein the computer code configured to censor the first party causes the at least one section of the data to be presented to at least one party of the plurality of parties but not to the first party.

22. The computer-readable medium of claim 12 wherein the computer program code configured to render the at least first section of the data for presentation to the group if the privilege level meets or exceeds the particular privilege level is further configured to render the at least first section of the data for presentation to the group in a meeting attended by the group.

23. An apparatus comprising:
means for identifying a group, the group including a plurality of parties;
means for determining an authorization associated with the group, the authorization being indicative of a privilege level associated with the group;
means for obtaining a set of data;
means for processing the set of data, wherein the means for processing the set of the data includes means for determining if the authorization indicates that at least a first section of the data is accessible to the group; and
means for rendering the at least first section of the data for presentation to the group if it is determined that the authorization indicates that the at least first section of the data is accessible to the group.

24. An apparatus comprising:
a communications interface, the communications interface being configured to establish a communications session through which privilege levels of a plurality of parties is obtained, the communications interface further being configured to obtain a set of data; and
a processing arrangement, the processing arrangement being configured to process the privilege levels of the plurality of parties to identify a representative privilege level, the processing arrangement further being configured to process the set of data to identify at least one section of the set of data that is permissible for viewing with the representative privilege; and
a rendering arrangement, the rendering arrangement being configured to render the at least one section of the set of data to the plurality of parties.

25. The apparatus of claim 24 wherein the communications interface is configured to establish the communications session with a calendaring server, the plurality of parties being a plurality of meeting attendees, wherein the communications session is established to obtain information relating to the plurality of meeting attendees.

26. The apparatus of claim 25 wherein the rendering arrangement is configured to render the at least one section of the set of data in a meeting attended by the plurality of meeting attendees.
